(19) United States
(12) Patent Application Publication
(10) Pub. No.: US 2021/0356902 A1
(43) Pub. Date: Nov. 18, 2021

(54) IMAGE FORMING APPARATUS

(71) Applicant: CANON KABUSHIKI KAISHA, Tokyo (JP)

(72) Inventors: Yuki TASHIRO, Chiba (JP); Takuya MATSUMURA, Chiba (JP)

(21) Appl. No.: 17/230,836

(22) Filed: Apr. 14, 2021

(30) Foreign Application Priority Data
May 15, 2020 (JP) 2020-086347

(51) Int. Cl. G03G 21/16

(52) U.S. Cl. CPC G03G 21/1619

(57) ABSTRACT

An image forming apparatus includes:
a sheet cassette;
an image forming unit configured to form an image on a sheet fed from the sheet cassette;
a first frame including: a first strut; a side plate spaced apart from the first strut; and a stay coupling the first strut and the side plate, the first frame supporting the sheet cassette, the sheet cassette being capable of slide-moving in a direction in which the stay extends;
a second frame provided on the first frame in a vertical direction, the second frame including a second strut coupled to the first strut, the second frame supporting the image forming unit; and
a grip provided pivotably at the first strut, the grip being graspable by an operator.

### BACKGROUND OF THE INVENTION

### Field of the Invention

The present invention relates to an image forming apparatus, such as an electrophotographic copying machine or an electrophotographic printer (e.g., a laser-beam printer or an LED printer).

### Description of the Related Art

Conventionally, known has been a configuration in which a first frame and a second frame disposed above the first frame in the vertical direction are coupled together as a frame of an image forming apparatus, similarly to a configuration in Japanese Patent Application Laid-Open No. 2005-134590. The first frame supports, for example, a sheet cassette which houses sheets. The second frame supports, for example, an image forming unit which forms an image on a sheet fed from the sheet cassette.

At the time of indoor installation of an image forming apparatus, the image forming apparatus requires lifting and conveying as work. In this respect, Japanese Patent Application Laid-Open No. 2005-134590 discloses a configuration in which the second frame is provided with grips that a worker grasps in order to lift the first frame and the second frame.

However, according to the configuration disclosed in Japanese Patent Application Laid-Open No. 2005-134590, in a case where the worker grasps any of the grips to lift the first frame and the second frame coupled together, the first frame results in being suspended by the second frame. In this case, the coupling portion between the first frame and the second frame is affected by the weight of most of the first frame, so that the coupling portion is likely to deform.

### SUMMARY OF THE INVENTION

It is desirable to provide an image forming apparatus enabling inhibition of the coupling portion between a first frame and a second frame from deforming at the time of grasping of a grip and lifting of the first frame and the second frame coupled together.

According to a representative configuration of the present invention, provided is an image forming apparatus including:

a sheet cassette configured to house a sheet;

an image forming unit configured to form an image on the sheet fed from the sheet cassette;

a first frame including: a first strut; a side plate spaced apart from the first strut; and a stay coupling the first strut and the side plate, the first frame supporting the sheet cassette, the sheet cassette being capable of slide-moving in a direction in which the stay extends;

a second frame provided on the first frame in a vertical direction, the second frame including a second strut coupled to the first strut, the second frame supporting the image forming unit; and a grip provided pivotably at the first strut, the grip being graspable by an operator.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus;

FIG. 2 is a perspective view of a frame of the image forming apparatus;

FIG. 3 is an exploded perspective view of the frame of the image forming apparatus;

FIG. 4 is a perspective view of the frame of the image forming apparatus;

FIG. 5A is a perspective view of an upper-right strut; FIG. 5B is a sectional view of the upper-right strut;

FIG. 6A is a perspective view of a lower-right strut; FIG. 6B is a sectional view of the lower-right strut;

FIG. 7A is a sectional view taken along line K3-K3 of the frame of the image forming apparatus; FIG. 7B is a sectional view taken along line K4-K4 of the frame of the image forming apparatus; FIG. 7C is a sectional view taken along line K5-K5 of the frame of the image forming apparatus;

FIG. 8A is a perspective view of the upper-right strut and the lower-right strut before coupling; FIG. 8B is a perspective view of the upper-right strut and the lower-right strut, which are being coupled together; FIG. 8C is a perspective view of the upper-right strut and the lower-right strut coupled together;

FIG. 9A is a plan view of the upper-right strut and the lower-right strut before coupling; FIG. 9B is a plan view of the upper-right strut and the lower-right strut, which are being coupled together; FIG. 9C is a plan view of the upper-right strut and the lower-right strut coupled together;

FIG. 10A is an enlarged perspective view of a grip housed in the lower-right strut; FIG. 10B is an enlarged perspective view of the grip projecting from the lower-right strut;

FIG. 11 is a graph of comparative experimental results of stress affecting the coupling portion between the upper frame and the lower frame; and

FIG. 12 is a schematic sectional view of an image forming apparatus.

### DESCRIPTION OF THE EMBODIMENTS

### First Embodiment

<Image Forming Apparatus>

The entire configuration of an image forming apparatus according to a first embodiment of the present invention will be described below together with the operation at the time of image forming with reference to the drawings. Note that, unless otherwise specified, the scope of the invention is not limited to the dimensions, materials, and shapes of the following constituent components and the relative arrangements thereof.

The image forming apparatus A according to the present embodiment is of an intermediate tandem type which transfers four-color toners of yellow Y, magenta M, cyan C, and black K to an intermediate transfer belt and then transfers an image to a sheet to form the image. Note that, in the following description, members which involve the yellow toner are denoted with Y as the suffix, members which involve the magenta toner are denoted with M as the suffix, members which involve the cyan toner are denoted with C as the suffix, and members which involve the black toner are denoted with K as the suffix. However, the configurations and operations of the members are substantially the same except for the colors of toner. Thus, the suffixes thereof will be appropriately omitted when no distinction is required.

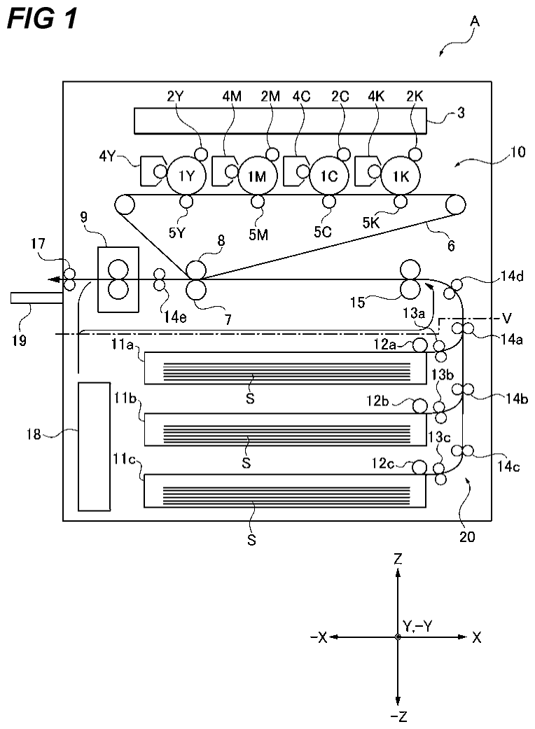

FIG. 1 is a schematic sectional view of the image forming apparatus A. As illustrated in FIG. 1, the image forming apparatus A includes: an image forming unit 10 which forms an image on a sheet S; and a feed unit 20 which feeds the sheet S to the image forming unit 10.

The image forming unit 10 includes photoconductive drums 1 (1Y, 1M, 1C, and 1K), charging rollers 2 (2Y, 2M, 2C, and 2K), and developing devices 4 (4Y, 4M, 4C, and 4K). The image forming unit 10 includes primary transfer rollers 5 (5Y, 5M, 5C, and 5K), a laser scanner unit 3, an intermediate transfer belt 6, a secondary transfer roller 7, and a secondary transfer counter roller 8.

The feed unit 20 includes: sheet cassettes 11a to 11c which each house sheets S; and pickup rollers 12a to 12c which each pick up a sheet S housed in the corresponding sheet cassette 11a, 11b, or 11c. The feed unit 20 includes: feed rollers 13a to 13c which each feed the sheet S picked up by the corresponding pickup roller 12a, 12b, or 12c to a conveyance path; conveying rollers 14a to 14d which each convey the sheet S on the conveyance path; and a registration roller 15.

At the time of formation of an image by the image forming apparatus A, first, an image forming job signal is input to a controller not illustrated. This arrangement causes a sheet S housed in any of the sheet cassettes 11a to 11c to be picked up by the corresponding pickup roller 12a, 12b, or 12c. Next, the sheet S is sent to the registration roller 15 by the corresponding feed roller 13a, 13b, or 13c and conveying roller 14a, 14b, 14c, or 14d. After that, the sheet S is subjected to correction of skew by the registration roller 15. Then, at a predetermined timing, the sheet S is sent to a secondary transfer portion formed by the secondary transfer roller 7 and the secondary transfer counter roller 8.

Meanwhile, in the image forming unit 10, first, the surface of the photoconductive drum 1Y is charged by the charging roller 2Y. After that, according to image data transmitted from external equipment not illustrated, the laser scanner unit 3 irradiates the surface of the photoconductive drum 1Y with laser light, to form an electrostatic latent image on the surface of the photoconductive drum 1Y. After that, the developing device 4Y causes the yellow tonner to adhere to the electrostatic latent image formed on the surface of the photoconductive drum 1Y, so that a yellow toner image is formed on the surface of the photoconductive drum 1Y. In response to application of a primary transfer bias to the primary transfer roller 5Y, the tonner image formed on the surface of the photoconductive drum 1Y is primary-transferred to the intermediate transfer belt 6.

In similar processes, a magenta toner image, a cyan toner image, and a black toner image are formed on the photoconductive drums 1M, 1C, and 1K, respectively. Then, in response to application of a primary transfer bias to each of the primary transfer rollers 5M, 5C, and 5K, the corresponding toner image is transferred so as to be superimposed on the yellow toner image on the intermediate transfer belt 6. This arrangement results in formation of a full-color toner image, corresponding to the image signal, on the surface of the intermediate transfer belt 6. Note that, after the primary transfer, the toners adhering to the photoconductive drums 1Y, 1M, 1C, and 1K are each removed by a cleaning member not illustrated, resulting in being collected in a toner collection container 18.

After that, the full-color toner image is sent to the secondary transfer portion by a circumferential run of the intermediate transfer belt 6. Then, in response to application of a secondary transfer bias to the secondary transfer roller 7, the full-color toner image on the intermediate transfer belt 6 is transferred to the sheet S at the secondary transfer portion. The sheet S to which the toner image is transferred is conveyed to a fixing device 9 by a conveying roller 14e. Then, the sheet S is subjected to heating and pressing by the fixing device 9, so that the toner image on the sheet S is fixed to the sheet S. After that, the sheet S to which the toner image is fixed is discharged to a discharge tray 19 by a discharge roller 17.

<Frame for Image Forming Apparatus>

Next, the configuration of a frame 100 for the image forming apparatus A will be described.

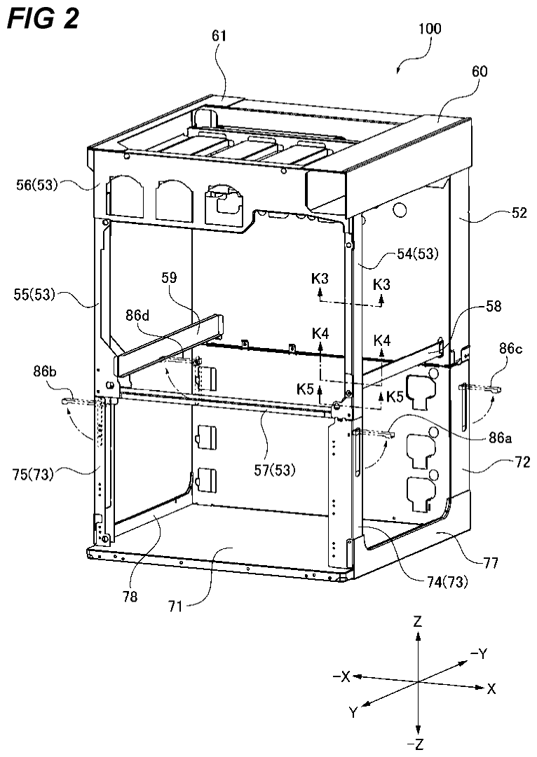

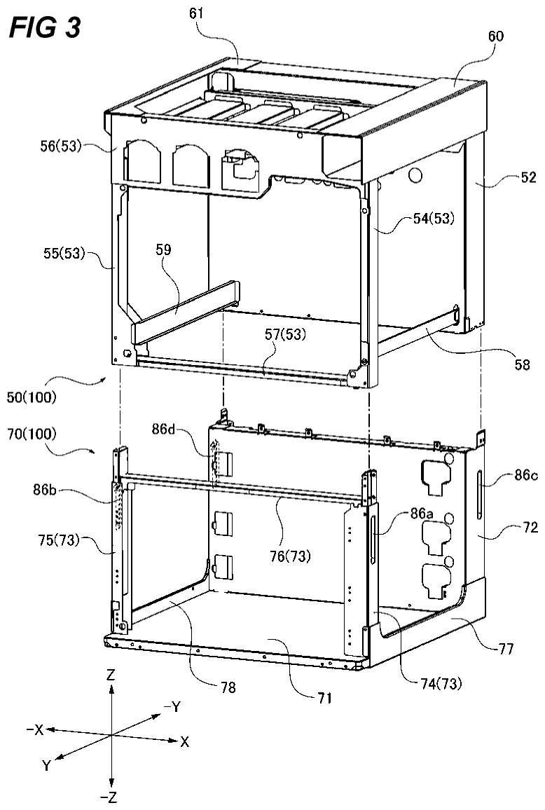

FIG. 2 is a perspective view of the frame 100 for the image forming apparatus A. FIG. 3 is an exploded perspective view of the frame 100 for the image forming apparatus A. As illustrated in FIGS. 2 and 3, the frame 100 for the image forming apparatus A includes an upper frame 50 and a lower frame 70 coupled together. The upper frame 50 and the lower frame 70 are each made of sheet metal. The upper frame 50 is disposed at the upper portion in the vertical direction of the lower frame 70. Note that the lower frame 70 is to be, as the frame 100, incorporated normally with the image forming apparatus A and thus is different from a cassette pedestal unit which is optionally attached as an option for functional extension, such as an increase in the number of sheets S to be housed. A dot-and-dash line V illustrated in FIG. 1 indicates the boundary between the upper frame 50 and the lower frame 70.

The upper frame 50 (second frame) includes a front plate 53, a rear plate 52, and stays 58, 59, 60, and 61 which couple the front plate 53 and the rear plate 52 together. The front plate 53 includes an upper-right strut 54 (second strut), an upper-left strut 55, and stays 56 and 57 which couple the upper-right strut 54 and the upper-left strut 55 together. The stays 56 and 57 are welded to the upper-right strut 54 and the upper-left strut 55. The stay 58 is welded to the upper-right strut 54 and the rear plate 52. The stay 59 is welded to the upper-left strut 55 and the rear plate 52. The stays 60 and 61 are welded to the stay 56 and the rear plate 52.

The lower frame 70 (first frame) includes a front plate 73, a rear plate 72, stays 77 and 78 which couple the front plate 73 and the rear plate 72 together, and a bottom plate 71. The front plate 73 includes a lower-right strut 74 (first strut), a lower-left strut 75 (third strut), and a stay 76 which couples the lower-right strut 74 and the lower-left strut 75 together. The stay 76 is welded to the lower-right strut 74 and the lower-left strut 75. The stay 77 is welded to the lower-right strut 74 and the rear plate 72. The stay 78 is welded to the lower-left strut 75 and the rear plate 72.

The bottom plate 71 of the lower frame 70 is provided with casters, not illustrated, enabling movement of the image forming apparatus A to an installation face for the image forming apparatus A. The rear plate 72, the lower-right strut 74, and the lower-left strut 75 are secured to a face of the bottom plate 71, the face being opposite to the other face of the bottom plate 71 to which the casters, not illustrated, are attached. In the lower frame 70, the lower-right strut 74, the lower-left strut 75, and both end portions in the directions of arrows X and −X of the rear plate 72 are provided, respectively, with grips 86a to 86d graspable, at the time of lifting of the image forming apparatus A, by an operator who operates the image forming apparatus A or a worker who conveys the image forming apparatus A. The grips 86a to 86d are used, for example, when the worker who is conveying the image forming apparatus A with the casters, not illustrated, lifts the image forming apparatus A to get over a step. The configuration of the grips 86a to 86d will be described in detail later.

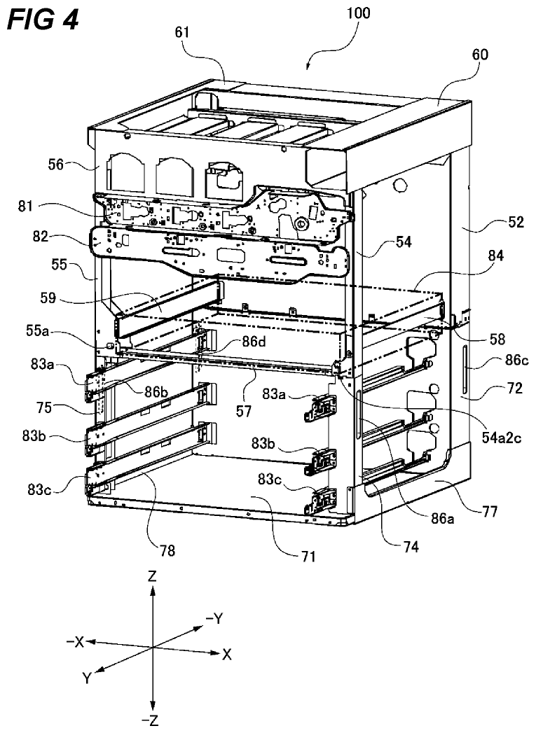

FIG. 4 illustrates the frame 100 for the image forming apparatus A, to which members which support the photoconductive drums 1 and the sheet cassettes 11 are attached. As illustrated in FIG. 4, a support member 81 which supports the photoconductive drums 1 and the developing devices 4, is positioned and attached to the upper-right strut 54 and the upper-left strut 55 of the upper frame 50. The support member 81 supports, rotatably, one end portion in the direction of the rotational axis of each of the photoconductive drums 1 and developing sleeves, not illustrated, included in the developing devices 4. The other end portion in the direction of the rotational axis of each of the photoconductive drums 1 and the developing sleeves is supported rotatably by the rear plate 52.

A belt support member 82 which supports the intermediate transfer belt 6 is positioned and attached to the upper-right strut 54 and the upper-left strut 55 of the upper frame 50. The belt support member 82 supports, rotatably, one end portion in the direction of the rotational axis of each of the secondary transfer counter roller 8 and the other rollers around which the intermediate transfer belt 6 is stretched. The other end portion in the direction of the rotational axis of the secondary transfer counter roller 8 is supported rotatably by the rear plate 52.

A front plate as the frame on the front side of a fixing and conveying unit 84 including the fixing device 9 and the conveying roller 14e united together, is attached to the upper-right strut 54 and the upper-left strut 55 of the upper frame 50. The position of the fixing and conveying unit 84 to the upper-right strut 54 and the upper-left strut 55 is determined by one-to-one fitting of pins, not illustrated, on the front plate of the fixing and conveying unit 84 to a fitting hole 54a2c formed on the upper-right strut 54 and a fitting hole 55a formed on the upper-left strut 55.

The conveying roller 14d (second conveying roller) is supported by the frame of the fixing and conveying unit 84. That is, determination of the position of the fixing and conveying unit 84 to the upper-right strut 54 and the upper-left strut 55 causes determination of the position of the conveying roller 14d. One end portion in the direction of the rotational axis of the conveying roller 14a (first conveying roller) which feeds a sheet S to the conveying roller 14d, is positioned to and then is supported rotatably by the lower-right strut 74. The other end portion in the direction of the rotational axis of the conveying roller 14a is supported rotatably by the rear plate 52.

A support rail 83a which supports the sheet cassette 11a, a support rail 83b which supports the sheet cassette 11b, and a support rail 83c which supports the sheet cassette 11c are positioned and attached to each of the lower-right strut 74 and the lower-left strut 75 of the lower frame 70. The support rails 83a, 83b, and 83c serve as stays (first guide portion and second guide portion) which couple the lower-right strut 74, the lower-left strut 75, and the rear plate 72 together. At the position between the lower-right strut 74 and the lower-left strut 75, the sheet cassettes 11a to 11c slide-move while being guided by the support rails 83a to 83c so as to be inserted in the direction of arrow −Y or so as to be drawn in the direction of arrow Y.

In the present embodiment, the front face of the image forming apparatus A is oriented in the direction of arrow Y in which the sheet cassettes 11a to 11c are drawable, and the rear face of the image forming apparatus A is oriented in the direction of arrow −Y in which the sheet cassettes 11a to 11c are insertable. The right face of the image forming apparatus A is oriented in the direction of arrow X orthogonal to the directions of arrows Y and −Y and the directions of arrows Z and −Z along the vertical direction. The left face of the image forming apparatus A is oriented in the direction of arrow −X inverse to the direction of arrow X. That is, in the direction of movement of the sheet cassettes 11a to 11c, the lower-right strut 74 and the lower-left strut 75 are disposed opposed to the rear plate 72 in the lower frame 70. The lower-right strut 74 and the lower-left strut 75 are disposed opposed to each other in the direction orthogonal to the direction of movement of the sheet cassettes 11a to 11c and the vertical direction.

<Struts>

Next, the configuration of the struts of the frame 100 for the image forming apparatus A will be described in detail. Note that the upper-right strut 54 and the lower-right strut 74 will be described below and are similar in configuration to the upper-left strut 55 and the lower-left strut 75, respectively.

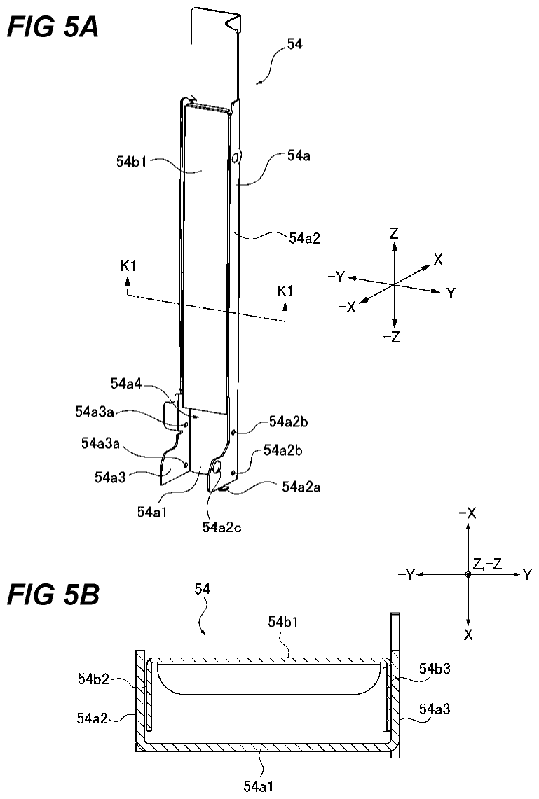

FIG. 5A is a perspective view of the upper-right strut 54. FIG. 5B is a sectional view of the upper-right strut 54 taken along line K1-K1 of FIG. 5A. As illustrated in FIGS. 5A and 5B, the upper-right strut 54 includes an outer member 54a and an inner member 54b which are coupled through a screw not illustrated. Note that provided may be a configuration in which the outer member 54a and the inner member 54b are coupled by welding, a configuration in which the outer member 54a and the inner member 54b are integrally molded by casting or stamping, or a configuration in which the outer member 54a and the inner member 54b are integrally formed by cutting.

The outer member 54a includes: a base portion 54a1; a bent portion 54a2 which is a substantially perpendicularly bent one end portion of the base portion 54a1; and a bent portion 54a3 (another bent portion) which is the substantially perpendicularly bent other end portion of the base portion 54a1 and is opposed to the bent portion 54a2. Thus, the outer member 54a has a U shape as a whole. Note that, in the present embodiment, the U shape of the outer member 54a results from one piece of sheet metal subjected to bending. However, a substantially U shape may be formed by combining two pieces of sheet metal, each having an L shape. The meaning “substantially perpendicular” herein includes not only an angle of 90 degrees of the bent portions 54a2 and 54a3 to the base portion 54a1 but also, for example, angles of 89 to 91 degrees in consideration of dimensional tolerance and manufacturing errors. The bent portions 54a2 and 54a3 may each have a step as long as the bent portions 54a2 and 54a3 are opposed to each other, substantially perpendicularly to the base portion 54a1. The bent portions 54a2 and 54a3 may each have a shape like an arc to the base portion 54a1.

The inner member 54b includes: a base portion 54b1; a bent portion 54b2 which is a substantially perpendicularly bent one end portion of the base portion 54b1; and a bent portion 54b3 (another bent portion) which is the substantially perpendicularly bent other end portion of the base portion 54b1 and is opposed to the bent portion 54b2. The inner member 54b has a U shape as a whole. Note that, in the present embodiment, the U shape of the inner member 54b results from one piece of sheet metal subjected to bending. However, a substantially U shape may be formed by combining two pieces of sheet metal, each having an L shape. The meaning “substantially perpendicular” herein includes not only an angle of 90 degrees of the bent portions 54b2 and 54b3 to the base portion 54b1 but also, for example, angles of 89 to 91 degrees in consideration of dimensional tolerance and manufacturing errors. The bent portions 54b2 and 54b3 may each have a step as long as the bent portions 54b2 and 54b3 are opposed to each other, substantially perpendicularly to the base portion 54b1. The bent portions 54b2 and 54b3 may each have a shape like an arc to the base portion 54b1.

The outer member 54a and the inner member 54b are disposed such that their U-shaped opening portions face each other. That is the base portion 54b1 of the inner member 54b is spaced apart from and opposed to the base portion 54a1 of the outer member 54a. The bent portion 54b2 of the inner member 54b is coupled to the bent portion 54a2 of the outer member 54a through a screw not illustrated. The bent portion 54b3 of the inner member 54b is coupled to the bent portion 54a3 of the outer member 54a through a screw not illustrated. This arrangement secures the rigidity of the upper-right strut 54 having a rectangular sectional shape. That is, the inner member 54b is part of the upper-right strut 54 and serves as a reinforcing member which reinforces the outer member 54a.

The bent portion 54a2 of the outer member 54a has screw holes 54a2b, and the bent portion 54a3 of the outer member 54a has screw holes 54a3a. The lower end portion of the bent portion 54a2 of the outer member 54a is provided with a protrusion 54a2a (engaging portion) protruding in the direction of arrow Y. With the lower end portion of the outer member 54a located below the lower end portion of the inner member 54b, provided is a reception portion 54a4 which has a space due to a portion of the outer member 54a protruding below the inner member 54b and receives the lower-right strut 74.

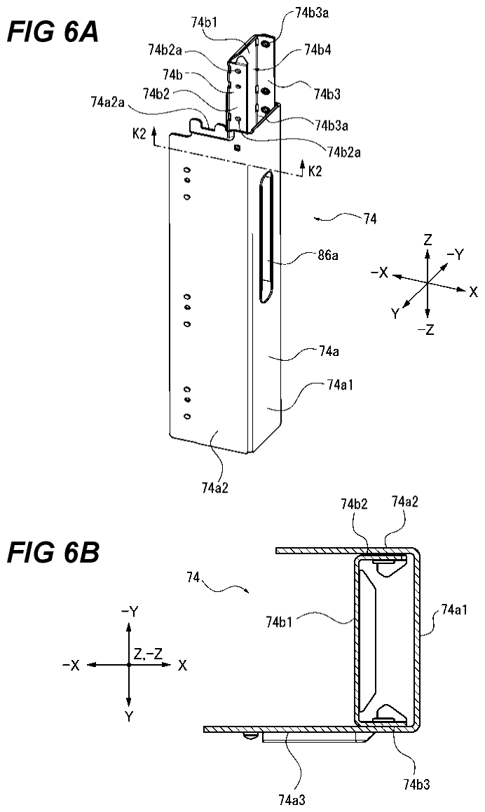

FIG. 6A is a perspective view of the lower-right strut 74. FIG. 6B is a sectional view of the lower-right strut 74 taken along line K2-K2 of FIG. 6A. As illustrated in FIGS. 6A and 6B, the lower-right strut 74 includes an outer member 74a and an inner member 74b which are coupled through a screw not illustrated. Note that provided may be a configuration in which the outer member 74a and the inner member 74b are coupled by welding, a configuration in which the outer member 74a and the inner member 74b are integrally molded by casting or stamping, or a configuration in which the outer member 74a and the inner member 74b are integrally formed by cutting.

The outer member 74a includes: a base portion 74a1; a bent portion 74a2 which is a substantially perpendicularly bent one end portion of the base portion 74a1; and a bent portion 74a3 (another bent portion) which is the substantially perpendicularly bent other end portion of the base portion 74a1 and is opposed to the bent portion 74a2. The outer member 74a has a U shape as a whole. Note that, in the present embodiment, the U shape of the outer member 74a results from one piece of sheet metal subjected to bending. However, a substantially U shape may be formed by combining two pieces of sheet metal, each having an L shape. The meaning “substantially perpendicular” herein includes not only an angle of 90 degrees of the bent portions 74a2 and 74a3 to the base portion 74a1 but also, for example, angles of 89 to 91 degrees in consideration of dimensional tolerance and manufacturing errors. The bent portions 74a2 and 74a3 may each have a step as long as the bent portions 74a2 and 74a3 are opposed to each other, substantially perpendicularly to the base portion 74a1. The bent portions 74a2 and 74a3 may each have a shape like an arc to the base portion 74a1.

The inner member 74b includes: a base portion 74b1; a bent portion 74b2 which is a substantially perpendicularly bent one end portion of the base portion 74b1; and a bent portion 74b3 (another bent portion) which is the substantially perpendicularly bent other portion of the base portion 74b1 and is opposed to the bent portion 74b2. The inner member 74b has a U shape as a whole. Note that, in the present embodiment, the U shape of the inner member 74b results from one piece of sheet metal subjected to bending. However, a substantially U shape may be formed by combining two pieces of sheet metal, each having an L shape. The meaning “substantially perpendicular” herein includes not only an angle of 90 degrees of the bent portions 74b2 and 74b3 to the base portion 74b1 but also, for example, angles of 89 to 91 degrees in consideration of dimensional tolerance and manufacturing errors. The bent portions 74b2 and 74b3 may each have a step as long as the bent portions 74b2 and 74b3 are opposed to each other, substantially perpendicularly to the base portion 74b1. The bent portions 74b2 and 74b3 may each have a shape like an arc to the base portion 74b1.

The outer member 74a and the inner member 74b are disposed such that their U-shaped opening portions face each other. That is the base portion 74b1 of the inner member 74b is spaced apart from and opposed to the base portion 74a1 of the outer member 74a. The bent portion 74b2 of the inner member 74b is coupled to the bent portion 74a2 of the outer member 74a through a screw not illustrated. The bent portion 74b3 of the inner member 74b is coupled to the bent portion 74a3 of the outer member 74a through a screw not illustrated. This arrangement secures the rigidity of the lower-right strut 74 having a rectangular sectional shape. That is, the inner member 74b is part of the lower-right strut 74 and serves as a reinforcing member which reinforces the lower-right strut 74.

The bent portion 74b2 of the inner member 74b has screw holes 74b2a, and the bent portion 74b3 of the inner member 74b has screw holes 74b3a. The upper end portion of the bent portion 74a2 of the outer member 74a is provided with a recessed portion 74a2a (engaged portion) which is recessed downward in the vertical direction. With the upper end portion of the inner member 74b located above the upper end portion of the outer member 74a, a portion of the inner member 74b protruding above the outer member 74a serves as a protruding portion 74b4 which is received by the reception portion 54a4 of the upper-right strut 54.

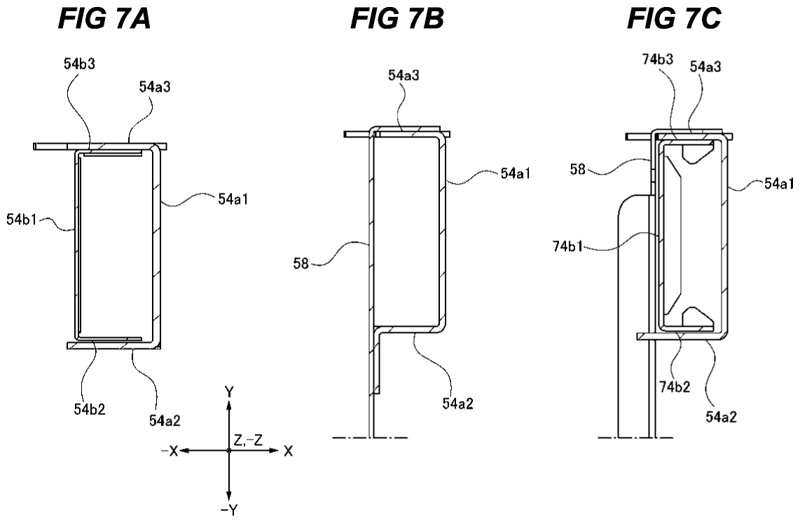

FIG. 7A is a sectional view of the frame 100 for the image forming apparatus A, taken along line K3-K3 of FIG. 2. FIG. 7B is a sectional view of the frame 100 for the image forming apparatus A, taken along line K4-K4 of FIG. 2. FIG. 7C is a sectional view of the frame 100 for the image forming apparatus A, taken along line K5-K5 of FIG. 2.

As illustrated in FIG. 7A, at the position of line K3-K3 of FIG. 2, a rectangular section is formed due to the outer member 54a and the inner member 54b of the upper-right strut 54. Specifically, the base portion 54a1, the bent portion 54a2, and the bent portion 54a3 of the outer member 54a, and the base portion 54b1 of the inner member 54b serve as the sides of the rectangular section. Note that the bent portion 54a2 of the outer member 54a and the bent portion 54b2 of the inner member 54b are disposed overlapping each other, and the bent portion 54a3 of the outer member 54a and the bent portion 54b3 of the inner member 54b are disposed overlapping each other.

As illustrated in FIG. 7B, at the position of line K4-K4 of FIG. 2, a rectangular section is formed due to the outer member 54a of the upper-right strut 54 and the stay 58. Specifically, the base portion 54a1, the bent portion 54a2, and the bent portion 54a3 of the outer member 54a, and the stay 58 serve as the sides of the rectangular section. That is, the stay 58 is coupled to the upper-right strut 54 such that a rectangular section is formed by the stay 58 together with the base portion 54a1, the bent portion 54a2, and the bent portion 54a3 of the outer member 54a between the inner member 54b of the upper-right strut 54 and the inner member 74b of the lower-right strut 74 in the vertical direction.

As illustrated in FIG. 7C, at the position of line K5-K5 of FIG. 2, a rectangular section is formed due to the outer member 54a of the upper-right strut 54 and the inner member 74b of the lower-right strut 74. Specifically, the base portion 54a1, the bent portion 54a2, and the bent portion 54a3 of the outer member 54a in the upper-right strut 54, and the base portion 74b1 of the inner member 74b in the lower-right strut 74 serve as the sides of the rectangular section. Note that the bent portion 54a2 of the outer member 54a in the upper-right strut 54 and the bent portion 74b2 of the inner member 74b in the lower-right strut 74 are disposed overlapping each other, and the bent portion 54a3 of the outer member 54a in the upper-right strut 54 and the bent portion 74b3 of the inner member 74b in the lower-right strut 74 are disposed overlapping each other.

As above, most of the upper-right strut 54 and the lower-right strut 74, which are the struts on the right side of the frame 100 for the image forming apparatus A, are rectangular in section regardless of position, resulting in enhancement in rigidity. Similarly, most of the upper-left strut 55 and the lower-left strut 75, which are the struts on the left side of the frame 100 for the image forming apparatus A, are rectangular in section regardless of position, resulting in enhancement in rigidity. Note that, in the present embodiment, the sectional shape of each strut is rectangular. However, any quadrilateral, such as a square, enables enhancement in rigidity, and thus the sectional shape may be square.

<Configuration of Coupling of Struts>

As described above, the image forming unit 10, the sheet cassettes 11a to 11c, and the conveying rollers 14a and 14d are directly or indirectly positioned by the upper-right strut 54, the lower-right strut 74, the upper-left strut 55, and the lower-left strut 75. Thus, at the time of coupling of the upper frame 50 and the lower frame 70, a low relative positional accuracy between the upper-right strut 54 and the lower-right strut 74 or a low relative positional accuracy between the upper-left strut 55 and the lower-left strut 75 causes deterioration in the relative positional accuracy between the conveying roller 14a and the conveying roller 14d. In this case, at the time of feed of a sheet S from the conveying roller 14a to the conveying roller 14d, the sheet S skews, causing a deviation in the image position to the sheet S, so that the image forming quality is likely to deteriorate. Note that the registration roller 15 performs correction of skew to the sheet S, but some levels of skew of the sheet S are likely to disable correction of skew. Thus, in the present embodiment, the following configuration inhibits the relative positional accuracy between each strut from deteriorating.

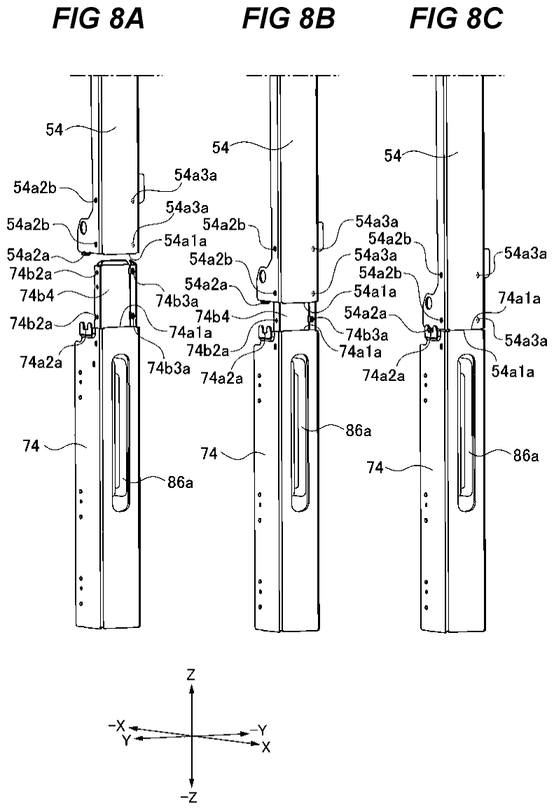

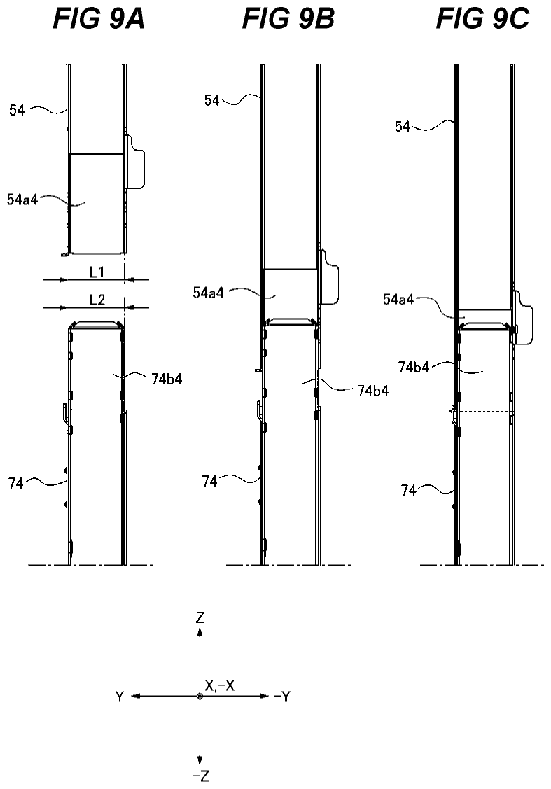

FIGS. 8A, 8B, and 8C are each a perspective view of the upper-right strut 54 and the lower-right strut 74. A process of coupling of the upper-right strut 54 and the lower-right strut 74 is illustrated in the order of FIGS. 8A, 8B, and 8C. FIGS. 9A, 9B, and 9C each illustrate the upper-right strut 54 and the lower-right strut 74 viewed in the direction of arrow −X. A process of coupling of the upper-right strut 54 and the lower-right strut 74 is illustrated in the order of FIGS. 9A, 9B, and 9C.

As illustrated in FIGS. 8A. 8B, 9A, and 9B, at the time of coupling of the upper-right strut 54 and the lower-right strut 74, first, a worker moves the upper-right strut 54 downward in the vertical direction, to insert the protruding portion 74b4 of the lower-right strut 74 into the reception portion 54a4 of the upper-right strut 54. At this time, with the bent portions 54a2 and 54a3 of the upper-right strut 54 in contact with the bent portions 74b2 and 74b3 of the lower-right strut 74, the upper-right strut 54 is guided to move in the vertical direction. The interval L1 between the inner face of the bent portion 54a2 and the inner face of the bent portion 54a3 of the upper-right strut 54 is wider by 0.5 mm than the interval L2 between the outer face of the bent portion 74b2 and the outer face of the bent portion 74b3 of the lower-right strut 74. Therefore, when the protruding portion 74b4 of the lower-right strut 74 is inserted into the reception portion 54a4 of the upper-right strut 54, the position in the direction of arrow Y of the upper-right strut 54 to the lower-right strut 74 is determined with a play of 0.5 mm.

Next, as illustrated in FIGS. 8C and 9C, the worker further moves the upper-right strut 54 downward in the vertical direction. Thus, a butt portion 54a1a which is the lower end portion of the base portion 54a1 of the upper-right strut 54 butts on a butt portion 74a1a which is the upper end portion of the base portion 74a1 of the lower-right strut 74, so that the position in the vertical direction of the upper-right strut 54 to the lower-right strut 74 is determined. The protrusion 54a2a at the bent portion 54a2 of the upper-right strut 54 fits to (engages with) the recessed portion 74a2a at the bent portion 74a2 of the lower-right strut 74. Thus, the position in the direction of arrow X of the upper-right strut 54 to the lower-right strut 74, namely, the movement in the direction orthogonal (crossing) to the vertical direction is regulated, so that the position in the direction orthogonal (crossing) to the vertical direction is determined.

As a result of such positioning between the upper-right strut 54 and the lower-right strut 74, the base portion 74a1 of the outer member 74a of the lower-right strut 74 is disposed adjacently to the base portion 54a1 of the outer member 54a of the upper-right strut 54 in the vertical direction. The upper end portion of the base portion 74a1 of the outer member 74a has contact with the lower end portion of the base portion 54a1 of the outer member 54a. The bent portion 74a2 of the outer member 74a of the lower-right strut 74 is disposed adjacently to the bent portion 54a2 of the outer member 54a of the upper-right strut 54 in the vertical direction. The bent portion 74a3 of the outer member 74a of the lower-right strut 74 is disposed adjacently to a bent portion 54a3 of the outer member 54a of the upper-right strut 54 in the vertical direction.

Next, the worker inserts screws, not illustrated, into the screw holes 54a2b at the bent portion 54a2 of the outer member 54a of the upper-right strut 54 and the screw holes 74b2a at the bent portion 74b2 of the inner member 74b of the lower-right strut 74, resulting in fastening. The worker inserts screws, not illustrated, into the screw holes 54a3a at the bent portion 54a3 of the outer member 54a of the upper-right strut 54 and the screw holes 74b3a at the bent portion 74b3 of the inner member 74b of the lower-right strut 74, resulting in fastening. Thus, the upper-right strut 54 and the lower-right strut 74 are coupled together. Thus, the position in the direction of arrow Y of the upper-right strut 54 to the lower-right strut 74, namely, the position in the direction orthogonal to the vertical direction is determined. As described above, due to the fitting between the protrusion 54a2a of the upper-right strut 54 and the recessed portion 74a2a of the lower-right strut 74 and the screw fastening between the upper-right strut 54 and the lower-right strut 74, the upper-right strut 54 and the lower-right strut 74 are secured with determination in omnidirectional position in the direction orthogonal to the vertical direction. That is, in the present embodiment, the inner member 74b of the lower-right strut 74 is part of the lower-right strut 74 and serves as a coupling member which couples the upper-right strut 54 and the lower-right strut 74. Note that the inner member 74b of the lower-right strut 74 and the outer member 54a of the upper-right strut 54 may be coupled by welding.

As above, in the present embodiment, positioning between the upper-right strut 54 and the lower-right strut 74 is performed directly by both struts. Therefore, in comparison to a configuration in which positioning is performed by members attached to the upper-right strut 54 and the lower-right strut 74, the influence of tolerance is lower, so that the relative positional accuracy between the upper-right strut 54 and the lower-right strut 74 can be inhibited from deteriorating. Thus, at the time of feed of a sheet S from the conveying roller 14a to the conveying roller 14d, the sheet S is inhibited from skewing, so that the image position to the sheet S can be inhibited from deviating.

<Grips>

Next, the configuration of the grips 86a to 86d which are grasped at the time of lifting of the image forming apparatus A, will be described. As described above, the grips 86a to 86d are provided at the lower-right strut 74, the lower-left strut 75, and both end portions in the directions of arrows X and −X of the rear plate 72, respectively. The four grips 86a to 86d are similar in configuration, and thus the grip 86a provided at the lower-right strut 74 will be described exemplarily herein.

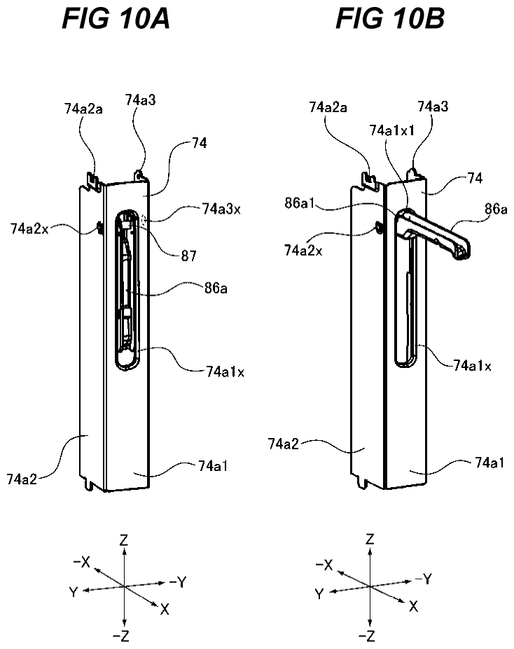

FIGS. 10A and 10B are each an enlarged perspective view of the grip 86a provided at the lower-right strut 74. FIG. 10A illustrates the grip 86a housed in the lower-right strut 74. FIG. 10B illustrates the grip 86a projecting from the lower-right strut 74. Note that the inner member 74b of the lower-right strut 74 is omitted in FIGS. 10A and 10B.

As illustrated in FIGS. 10A and 10B, the base portion 74a1 of the outer member 74a of the lower-right strut 74 has, due to drawing, a through hole 74a1x passing in the direction of thickness of the base portion 74a1 (direction of arrow X). The bent portion 74a2 of the outer member 74a of the lower-right strut 74 has, due to drawing, a through hole 74a2x passing in the direction of thickness of the bent portion 74a2 (direction of arrow Y). The bent portion 74a3 of the outer member 74a of the lower-right strut 74 has, due to drawing, a through hole 74a3x passing in the direction of thickness of the bent portion 74a3 (direction of arrow Y).

The grip 86a has a through hole, not illustrated, passing in the direction of arrow Y. A shaft 87 inhibited from coming off is inserted in the through hole, not illustrated, of the grip 86a and the through holes 74a2x and 74a3x of the lower-right strut 74. Thus, the grip 86a is supported pivotably around the shaft 87 as a pivot to the lower-right strut 74. That is, in the free state, the grip 86a has the center of pivoting above a portion that a user grasps, in the vertical direction. The grip 86a pivots between the position at which the grip 86a is housed in the through hole 74a1x of the lower-right strut 74 (first position) and the position at which the grip 86a projecting from the through hole 74a1x is graspable by the user (second position). As illustrated in FIG. 10A, at the first position, the grip 86a is supported by the shaft 87 such that the direction in which the lower-right strut 74 extends and the direction in which the grip 86a extends are identical. Note that, in the present embodiment, as the state where the grip 86a is housed in the lower-right strut 74, at least part of the grip 86a requires locating inside the through hole 74a1x of the lower-right strut 74, and thus the entirety of the grip 86a may be located inside the through hole 74a1x.

For use of the grip 86a, a worker pivots the grip 86a, so that the grip 86a projects from inside the through hole 74a1x of the lower-right strut 74. When an abutting portion 86a1 near the proximal portion of the grip 86a abuts on an abutting portion 74a1x1 which is the upper end portion of the inner wall of the through hole 74a1x, the pivoting is regulated, so that the projecting grip 86a stops. As illustrated in FIG. 10B, at the second position, the pivoting of the grip 86a is regulated by the abutting portion 74a1x1 such that the direction in which the lower-right strut 74 extends and the direction in which the grip 86a extends are substantially perpendicular to each other. That is, the angle of the grip 86a to the lower-right strut 74 at the second position is larger than an angle at the first position.

The worker grasps the grip 86a projecting and having been regulated in pivoting, to lift the image forming apparatus A. In this way, the grip 86a is used. When the worker releases the hand from the grip 86a after lowering the image forming apparatus A, the grip 86a pivots, due to its own weight, to the inside of the through hole 74a1x of the lower-right strut 74, so that the grip 86a is housed in the lower-right strut 74. That is, in the free state, the grip 86a is located at the position at which the grip 86a is housed in the lower-right strut 74.

As above, in the present embodiment, in the image forming apparatus A with the frame 100 including the upper frame 50 and the lower frame 70 coupled together, the lower frame 70 is provided with the grips 86a to 86d. With such a configuration, at the time of lifting of the image forming apparatus A with the grips 86a to 86d grasped, most of the weight of the lower frame 70 is received by the abutting portions between the lower frame 70 and the grips 86a to 86d. Therefore, the coupling portion between the upper frame 50 and the lower frame 70 is inhibited from being affected by the weight of the lower frame 70, so that the coupling portion can be inhibited from deforming.

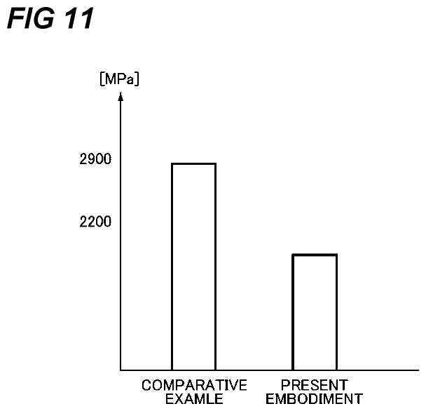

FIG. 11 is a graph of comparative experimental results of stress affecting the coupling portion between the upper frame 50 and the lower frame 70 at the time of lifting of the image forming apparatus A, between the configuration according to the present embodiment and a configuration according to a comparative example. In the configuration according to the comparative example, both end portions in the directions of arrows X and −X of the rear plate 52, the upper-right strut 54, and the upper-left strut 55 in the upper frame 50 are each provided with a grip.

As illustrated in FIG. 11, the configuration according to the present embodiment is lower than the configuration according to the comparative example by 43% in stress affecting the coupling portion between the upper frame 50 and the lower frame 70. As above, from the experimental results, it has been verified that the configuration according to the present embodiment inhibits the coupling portion between the upper frame 50 and the lower frame 70 from deforming.

Note that, in the present embodiment, given has been the configuration in which the image forming unit 10, the sheet cassettes 11a to 11c, and the conveying rollers 14a and 14d are positioned by the front plate 53 of the upper frame 50 and the front plate 73 of the lower frame 70. However, the present invention is not limited to this. That is the members may be positioned by the rear plate 52 of the upper frame 50 and the rear plate 72 of the lower frame 70.

In the present embodiment, the through hole 74a1x of the lower-right strut 74 serves as a housing portion in which the grip 86a is housed. However, the present invention is not limited to this. Thus, a space in which at least the grip 86a is housed requires providing. That is, as a hole portion in which the grip 86a is housed, provided may be a through hole or a recessed portion having a bottom face.

In the present embodiment, the image forming apparatus A is assumed to be conveyed at a stage before attachment of an exterior cover. That is, assumed is conveyance with the frame 100 exposed. In a case where the image forming apparatus A is assumed to be conveyed after attachment of the exterior cover, portions of the exterior cover corresponding to the grips 86a to 86d disposed may have holes for exposure of the grips 86a to 86d from the exterior cover.

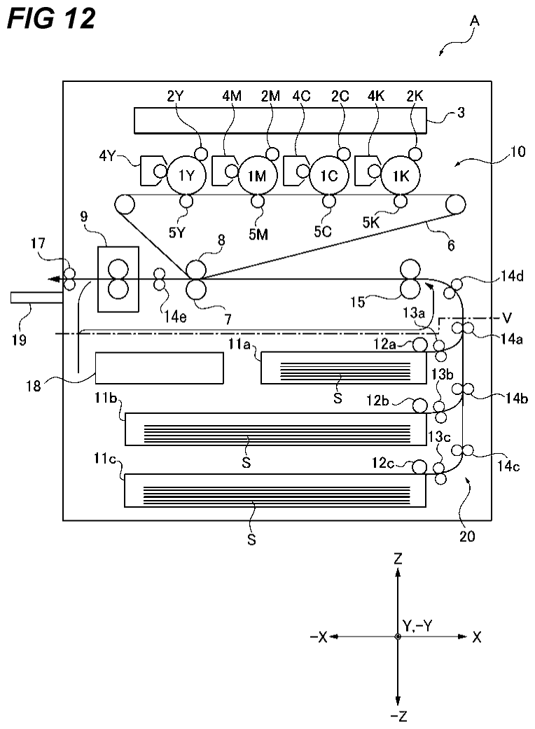

The arrangement of each member supported by the upper frame 50 or the lower frame 70 can be changed appropriately. For example, as illustrated in FIG. 12, the sheet cassette 11a, which is supported by the lower frame 70, may be miniaturized to house small-sized sheets S. In addition, the toner collection container 18 may be disposed at a space resulting from the miniaturization.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-086347, filed May 15, 2020 which is hereby incorporated by reference herein in its entirety.

What is claimed is:

1. An image forming apparatus comprising:
a sheet cassette configured to house a sheet;
an image forming unit configured to form an image on the sheet fed from the sheet cassette;
a first frame including: a first strut; a side plate spaced apart from the first strut; and a stay coupling the first strut and the side plate, the first frame supporting the sheet cassette, the sheet cassette being capable of slide-moving in a direction in which the stay extends;
a second frame provided on the first frame in a vertical direction, the second frame including a second strut coupled to the first strut, the second frame supporting the image forming unit; and
a grip provided pivotably at the first strut, the grip being graspable by an operator.

2. The image forming apparatus according to claim 1, wherein
the grip has a pivot at an upper portion of the grip in the vertical direction, the pivot being secured rotatably to the first strut, and
the grip pivots between a first position at which the grip is supported in a free state to the first strut and a second position at which an angle of the grip to the first strut is larger than that of the first position.

3. The image forming apparatus according to claim 2, wherein
the grip in the free state is located at the first position.

4. The image forming apparatus according to claim 2, wherein
the first strut is provided with a hole portion in which the grip located at the first position is housed, and
in pivoting of the grip, the grip abuts on an inner wall of the hole portion such that the pivoting of the grip is regulated at the second position.

5. The image forming apparatus according to claim 1, wherein
the first frame includes:
a side plate spaced apart from the first strut;
a third strut spaced apart from the first strut and the side plate;
a first guide portion coupling the first strut and the side plate, the first guide portion supporting the sheet cassette slide-movably; and
a second guide portion coupling the third strut and the side plate, the second guide portion supporting the sheet cassette slide-movably together with the first guide portion, and
the sheet cassette is capable of slide-moving between the first strut and the third strut.

6. The image forming apparatus according to claim 5, wherein
the third strut is provided with another grip.

7. The image forming apparatus according to claim 6, wherein
the other grip is supported pivotably to the third strut, and
the other grip pivots between a third position at which the other grip is housed in the third strut and a fourth position at which the other grip projects from the third strut.

8. The image forming apparatus according to claim 7, wherein
the other grip in a free state is located at the third position.

9. The image forming apparatus according to claim 7, wherein
the third strut has another hole portion in which the other grip is housed, and
in pivoting of the other grip from the third position to the fourth position, the other grip abuts on an inner wall of the other hole portion such that the pivoting of the other grip is regulated.

10. The image forming apparatus according to claim 6, wherein
other grips which are different from the grip and the other grip, are provided at both end portions of the side plate in a direction orthogonal to a direction of movement of the sheet cassette and the vertical direction.

11. The image forming apparatus according to claim 5, wherein
the first frame includes a bottom plate provided with casters enabling movement of the image forming apparatus to an installation face, and
the first strut, the third strut, and the side plate are secured to a face of the bottom plate, the face being opposite to another face of the bottom plate to which the casters are attached.
